(19) United States
(12) Patent Application Publication
(10) Pub. No.: US 2006/0093833 A1
(43) Pub. Date: May 4, 2006

(54) Components having crystalline coatings of the aluminum oxide/silicon oxide system and method for the production thereof

(76) Inventors: Dirk Meyer, Dresden (DE); Alexandr Levin, Dresden (DE); Peter Paufler, Dresden (DE)

Correspondence Address: GUDRUN E. HUCKETT DRAUDT, LONSSTR. 53, WUPPERTAL, 42289, DE

(21) Appl. No.: 10/513,028

(22) PCT Filed: Apr. 30, 2003
(86) PCT No.: PCT/DE03/01440

§ 371 Date: Sep. 16, 2005

(30) Foreign Application Priority Data
Mar. 5, 2002 (DE) 102-19-812.8

(51) Int. Cl. C03C 17/23; C03B 37/00; C03C 10/00; B32B 17/06; B32B 13/04; B32B 9/00

(52) U.S. Cl. 428/432; 65/33.4; 65/33.2; 65/32.3; 65/32.4; 428/446; 428/701; 428/702

(57) ABSTRACT

A component has a substrate of silicon or silicate glass and a crystalline aluminum silicate coating of the system aluminum oxide/silicon oxide. The crystalline aluminum silicate coating is intergrown with the substrate so as to form an intermixed zone, wherein the intermixed zone has at least one of a concentration gradient and a structure gradient. The component is prepared by applying an aluminum oxide layer on a substrate of silicon or silicate glass and by carrying out a heat treatment under vacuum conditions at temperatures greater than 1100° C. during or after the step of applying.

The invention relates to components having crystalline coatings of the aluminum oxide/silicon oxide system and methods for their manufacture for generating hard layers on silicon or silicate glass substrates as a material for hard and chemically resistant high-temperature coatings. Excellent adhesion properties result from the intergrowth of the layers with the substrates which is characterized by the presence of expansive structure and/or concentration gradients, in particular in the boundary layer area.

Because of their properties, aluminum oxide and silicon oxide are of interest also as materials for coatings. In this connection, in addition to the high hardness obtainable for individual crystalline modifications, the optical properties are also decisive. While silicon dioxide is the most important base material for the manufacture of refractive optical devices (in glass-like state as well as in crystalline state), it is possible to realize, for example, anti-reflective layers for lasers by application of thin aluminum oxide layers on these optical devices or, by combination with silicon oxide layers, dielectric filters for the broad wavelength range of 0.3-5.0 μm that can be employed without being destroyed at very high power densities.

Crystalline aluminum oxide is present, for example, in a technically especially interesting modification as corundum (α-aluminum oxide). Corundum is a highly valued material primarily because of its great hardness (Mohs' hardness 9; for simple hardness determination according to Mohs as well as other methods, see e.g. F. Kohirausch, Praktische Physik, vol. 1; B. G. Teubner, Stuttgart, 1968, p 175ff) but also because of its chemical indifference and its high melting point. Natural corundum is the second hardest known natural mineral after diamond. A further modification is γ-aluminum oxide that has a spinell structure with defects and is less compact in comparison. Natural aluminum oxide protective layers on metallic aluminum have usually a NaCl structure with defects.

Crystalline silicon oxide, for example, is present in the modifications quartz, cristobalite, or tridymite that can be transformed into one another depending on the temperature. For technical applications, however, often glass-like material based on silicon oxide is of interest, i.e., the formation of one of the crystalline modifications is then to be prevented. Glass-like materials on the basis of silicon oxide can be obtained, for example, by admixture of sodium oxide to the melt.

DE 100 12 316 A1 discloses a method for coating quartz components with a fixedly adhering layer of aluminum oxide as a protection against chemical reactions. For coating the quartz components, either the application of a protective layer by physical deposition from the vapor phase or by chemical deposition from the gas phase or by application of an aluminum layer and subsequent post-oxidation (under atmospheric conditions, 15 minutes at 800° C.) is proposed. DE 100 12 316 A1 is not designed to generate a defined modification of the crystal structure.

When applying layers onto substrates or as a result of effects that occur later, solid-state reactions can occur at the boundary layer and, after intermixing, can enable the formation of other crystalline phases. In the system silicon/aluminum/oxygen, different modifications of the structure of the crystalline state are also known. For the Al₂SiO₅ group, the three modifications kyanite, andalusite, and sillimanite are known for certain. In the case of natural deposits, it is possible to derive the effective pressure at the time of formation based on the modification that is present. While the triclinic kyanite has direction-dependent Mohs' hardness of 4-7, the rhombic modifications andalusite and sillimanite have values of 7.5 or 6-7 according to Mohs. Accordingly, in the context of the above presentation, layers of the Al₂SiO₅ group are also of interest as mechanically protective layers (having also multiple technically useful optical properties).

When solid bodies of the Al₂SiO₅ group or of combinations of aluminum oxide and silicon oxide are heated to sufficiently high temperatures (usually above 1000° C.), the formation of mullite is possible. Based on the hardness that is also high(up to 7.5 according to Mohs), the great heat resistance but also primarily because of the high resistance against chemical and physical erosion, mullite is of great importance as a refractory material for chemical reactors and high-temperature furnaces.

It is knowing that amorphous aluminum oxide present at room temperature can be transformed into crystalline modifications by a suitable heat treatment. When the temperature is increased according to an appropriate regime slowly or in a stepped fashion, the crystalline phase that is often observed first at temperatures in the range of approximately 1000° C. is γ-aluminum oxide that, after extended heat treatment at this temperature, faster at higher temperatures up to approximately 1200° C., can also be transformed into α-aluminum oxide (see e.g., T. C. Chou, D. Adamson, J. Mardinly, and T. G. Nieh; Thin Solid Films, 205 (1991) 131-139; unfortunately, there is no information regarding the pressure conditions/gas composition of the atmosphere during the treatment). When amorphous aluminum oxide layers on sapphire substrate are treated in this way, the crystallization can be successfully realized based on the crystalline substrate and assisted by the thus predetermined structure information by means of solid-state epitaxy (see e.g., T. W Simpson, Q. Wen, N. Yu, and D. R. Clarke, J. Am. Ceram. Soc., 81(1) (1998) 61-66). For technical applications, on the other hand, generally the generation of monocrystalline or textured layers (polycrystalline layers with preferred orientation of the crystallites) from aluminum oxide on substrates of other materials is required.

The object of the present invention resides in making available components with a hard and chemically resistant coating of the system aluminum oxide/silicon oxide with high adhesion as well as a method therefor.

According to the invention, this object is solved by components with crystalline coatings of the system aluminum oxide/silicon oxide in which the crystalline aluminum silicate coating and the substrate of silicon or silicate glass are intergrown and an intermixed zone with a concentration and/or structure gradient is present.

According to the invention, the crystalline coating of the system aluminum oxide/silicon oxide is obtained such that, during or after application of aluminum oxide layers on supports or substrates of silicon or silicate glass, a heat treatment under vacuum conditions at temperatures greater than 1100° C. is carried out. Preferably, the heat treatment is carried out at a pressure of less than 5×10³ Pa.

The method according to the invention enables the formation of crystalline modifications of the system aluminum/silicon/oxide by reaction of the layer with parts of the substrate. In this connection, the substrate makes available silicon or silicon oxide (silicon that is stored in air forms natural silicon oxide layers whose thickness can be expanded by thermal oxidation, for example, up to the micrometer range) for the formation of crystalline modification of the Al₂SiO₅ group or mullite formation.

The method according to the invention leads to a structure of a generally thermally stimulated solid-state reaction between aluminum oxide and the substrate. The simultaneously realized intergrowth of the layers with the substrates, characterized in particular by the presence of expansive structure and concentration gradients particularly within the boundary layer area, provides very advantageous adhesion properties that are maintained for loads of very different kinds.

A concentration gradient is obtained in this connection by interdiffusion of the components of the aluminum oxide layer and of the substrate. In this connection, for predetermined boundary conditions the transport of individual components can be preferred. Since the formation of the individual crystalline modifications in addition to the activation energy, which is made available primarily by the process temperature, requires certain chemical compositions (usually within certain intervals), the concentration gradient can also cause a structure gradient for the present method. An advantage of such a structure gradient is the successive transition between two solid bodies with different crystal structure (in this connection, it is also possible for one component to start with an amorphous structure). For abrupt transitions, the adhesion capability is usually significantly lower because the influence of the defect of both crystal structures or the limited variance of the binding possibilities has disadvantageous effects. Moreover, for example, different thermal expansion coefficients of layer and substrate can lead to chipping of the layer in the case of a temperature change during technical usage.

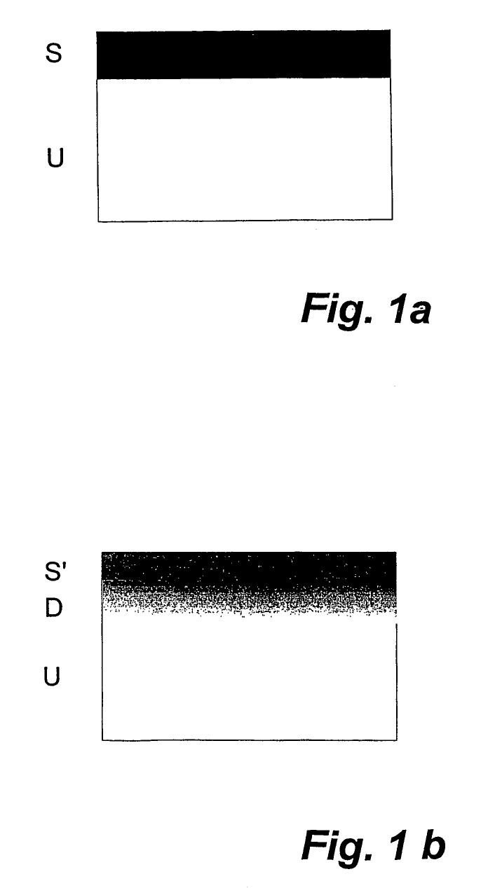

Based on FIGS. 1a and 1b, the invention will be explained in more detail. On a substrate (U) of silicate glass a layer (S) of aluminum oxide is deposited in a first process step wherein, according to FIG. 1a, a sharp boundary layer (U)-(S) is formed (formation of a neglectable intermixing zone within the magnitude of less than 1 nm, depending on the employed method). After performing a temperature treatment according to the invention in a second process step, an expansive intermixing zone (D) of the components in question is formed according to FIG. 1b wherein parts of the substrate (U) and the entire layer can be involved.

Under the process conditions according to the invention, in addition to the concentration gradient a structure gradient is obtained starting from the substrate (the latter can be amorphous) through the new layer (S′, up to the realization of the desired crystalline modification for the volume areas that are sufficiently expanded for the desired properties).

The invention comprises also the possibility of adjustment of the required parameters during the application of the layers or directly subsequent thereto. For this purpose, a substrate heating device can be employed that is active during the deposition of the layers, for example.

The method according to the invention can also be realized as a post-treatment of layers. By doing so, it is possible to employ for the deposition of the primary aluminum oxide layers inexpensive industrially realized methods having high processing speed because firstly the aluminum or aluminum oxide must only be deposited on the substrate (aluminum can be thermally oxidized in a simple way past the natural oxide layer formation in air so that in the following in generalized terms aluminum oxide is mentioned at this point of the pre-treatment). With the method according to the invention it is possible to generate in a targeted fashion the desired structural modifications also on glass-like substrates without the required process temperature surpassing the devitrification temperature of important silicate glasses so that these substrates remain unchanged with regard to their physical properties.

In an advantageous embodiment, heating of the aluminum oxide layers as well as of the areas primarily at the boundary layer between the substrate and the layer as well as the adjoining substrate areas can be realized by the absorption of electromagnetic radiation with wavelengths of the radiation in the ultraviolet range. The localization of the intensively heated zone onto this area is successful for most silicate glasses because the level of absorption for electromagnetic radiation in this wavelength range is significantly greater for aluminum oxide than for these glasses. In addition, by means of a grazing impinging action of the radiation relative to the layer surface the total absorption level can be increased more in favor of the layer. This form of targeted local heating enables also coating of silicate glasses having lower devitrification temperature in accordance with the invention.

Preferably, laser radiation having a wavelength in the UV range is employed as electromagnetic radiation. Advantageously, the laser radiation impinges in a grazing fashion, almost parallel to the substrate surface, so that in this way the penetration depth into the substrate is limited.

According to the invention, a hard and scratch-resistant coating of optical glasses (for example, for optical lenses and mirrors) is obtained that remains stable even at greater temperature fluctuations (for example, as a result of absorption of certain spectral proportions of the light for discontinuous operation).

With the aid of the following embodiments the invention will be explained in more detail.

### EXAMPLE 1

Onto monocrystalline silicon substrates with natural oxide layer, aluminum oxide is deposited by means of electron beam evaporation (layer thicknesses approximately 70 nm). The starting substrates coated in this way are subsequently subjected to a temperature treatment in vacuum (pressure less than 5*10³ Pa, laboratory tube furnace of the company Linn Elektro Therm, duration 2 hours). For characterizing the crystalline phases that are present, these samples are examined by means of x-ray diffractometry (measuring device: x-ray diffractometer URD-6 of the company Freiberger Präzisionsmechanik, Cu—K α-radiation). In this connection, by means of an electronic detection system as a function of the diffractometer angle 2θ, the intensity of the radiation scattered by the sample is measured.

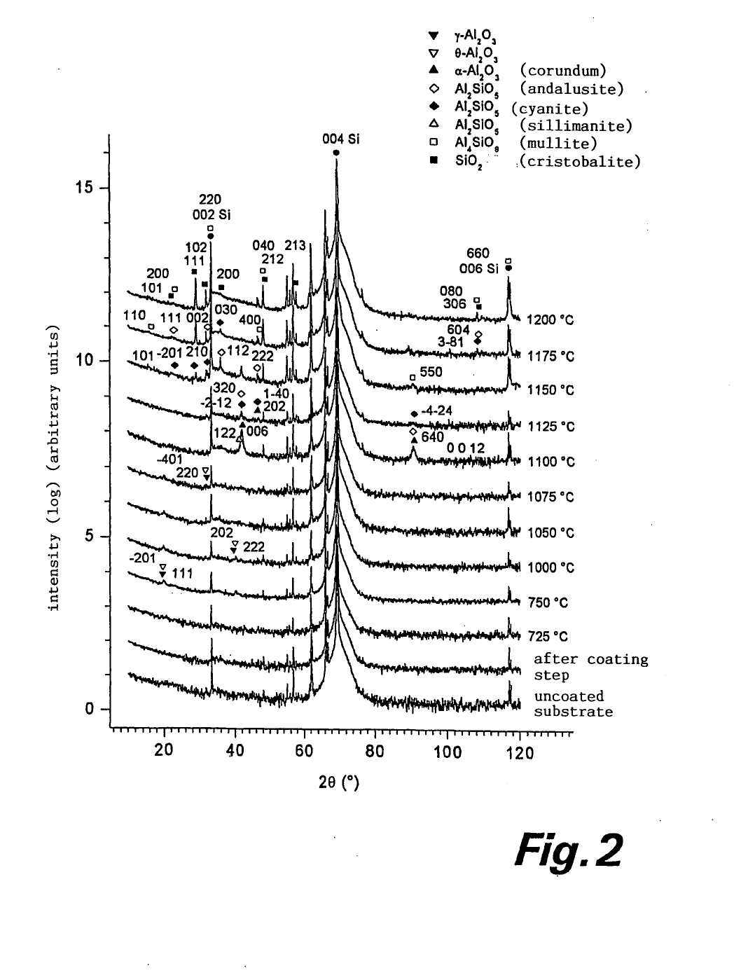

In FIG. 2, the x-ray diffractograms of the samples treated at different temperatures are illustrated. Each diffractogram has correlated therewith the temperature at which the examined sample has been treated. Reflexes occur when a crystalline order is present; their angle position and also intensity enable statements in regard to the crystalline structure of the examined materials (by computation or by comparison with data collections of known structures).

Since the layers of the samples (thickness approximately 70 nm) are penetrated easily by the x-ray radiation in the case of the employed symmetric beam geometry, in each diffractogram the very strong contribution of the reflexes of the monocrystalline substrate can be recognized (as a comparison, the diffractogram of the uncoated substrate is also provided). The sequences of three numerals in the illustration correspond to the reflex indices relative to the indicated crystalline phases. The coated sample without temperature and vacuum treatment has no additional reflexes of the layer—the layer appears structurally amorphous relative to x-ray diffraction.

Up to a temperature of 750° C. no measurable changes occur in comparison to the uncoated substrate.

The beginning of a crystallization of the layers is observed after a heat treatment of the samples at 750° C. The reflexes can be correlated with the modifications γ-Al₂O₃ or θ-Al₂O₃. In the sample treated at 1100° C., reflexes are observed in the correlated diffractogram that can be correlated with the corundum modification of aluminum oxide or also to the crystal structures of the Al₂SiO₅ group. Even though a proper correlation is made more difficult in this connection, all structures that are possible here have a high hardness and also chemical resistance.

The samples that have been treated at temperatures above 1125° C. have a significantly reduced intensity of the reflexes. This underscores the minimal width of the temperature interval for the optimal formation of these structures. The condition that within the selected measuring geometry only individual reflexes of the corresponding phases can be identified, can be explained with the presence of a strong fiber texture of the crystalline layer areas.

Heat treatments of the samples at temperatures above 1150° C. lead to increased formation of mullite (Al₄SiO₈). This phase is extremely interesting as a material for hard and chemically resistant high-temperature coatings. In the present case, aside from mullite the silicon oxide modification cristobalite is observed also. A possible embedding of the cristobalite in a matrix of mullite can be advantageous with regard to thermal and mechanical resistance of the layer (it is known that the addition of cristobalite to glazes can prevent the formation of hairline cracks). Important in regard to practical use is that the temperatures required for the heat treatment are below the devitrification temperature of a series of important glasses so that an undesirable change of the properties of these substrates can be prevented.

When the property of the boundary layer between coating and substrate is examined by means of x-ray reflectometry, an excellent boundary layer between coating and substrate can still be observed for a heat treatment up to 1075° C.; this is an indication of a sharp jump of the concentration of the components of the layer and the substrate. The basis for the method of x-ray reflectometry is the interference of partial beams of an x-ray beam that is directed at small angles onto the surface of the layer (˜1°) which partial beams are formed by partial reflection at the air/layer boundary layer or the boundary layer of layer/substrate. Based on the interference images that are measured angle-dependently, it is then possible to draw conclusions in regard to the thickness of the layer and the quality of the aforementioned boundary layers or interfaces.

When samples are treated at temperatures starting at 1100° C., no indication in regard to a sharply localized boundary layer can be found any longer by means of the method of x-ray reflectometry. This method shows an expansive intermixing zone with a concentration gradient.

### EXAMPLE 2

On substrates of silicate glass, by means of reactive magnetron ion beam atomization of an aluminum oxide target in a plasma containing argon and oxygen, a layer of aluminum oxide is deposited (with regard to the method see, e.g. T. C. Chou et al.; complete citation supra in the text of the description).

For forming the desired crystalline modifications of the Al₂SiO₅ group, the deposited layers and substrates are subjected to a heat treatment under the conditions provided in Example 1 in regard to vacuum and temperature.

The examination of the samples by means of x-ray diffractometry and x-ray reflectometry provides results that are comparable to those of Example 1. The samples that are treated in the range of the temperatures provided therein comprise also the desired hard modifications. While generally the real structure of the layers that is characteristic for the deposition method and the deposition conditions as well as the property of the boundary layer have an effect on subsequent thermally stimulated solid-state reactions, even when selecting silicate glass as a substrate no significant differences can be observed for the two methods of the two embodiments that are important for industry-technological applications.

What is claimed is:

1-8. (canceled)

9. A component comprising a substrate of silicon or silicate glass and a crystalline aluminum silicate coating of the system aluminum oxide/silicon oxide, wherein the crystalline aluminum silicate coating is intergrown with the substrate so as to form an intermixed zone, wherein the intermixed zone has at least one of a concentration gradient and a structure gradient.

10. A method for generating a crystalline aluminum silicate coating of the system aluminum oxide/silicon oxide, the method comprising the steps of:
applying an aluminum oxide layer on a substrate of silicon or silicate glass;
during or after the step of applying, carrying out a heat treatment under vacuum conditions at temperatures greater than 1100° C.

11. The method according to claim 10, wherein the heat treatment is carried out at a pressure of less than 5×10³ Pa.

12. The method according to 10, wherein, in the step of carrying out the heat treatment, the aluminum oxide layer is heated by electromagnetic radiation while heating of the substrate is substantially avoided.

13. The method according to claim 12, wherein the electromagnetic radiation is laser radiation.

14. The method according to claim 13, wherein the laser radiation has a wave length within the UV range.

15. The method according to claim 13, wherein the laser radiation impinges grazingly, almost parallel to the substrate surface, on the aluminum oxide layer and a penetration depth of the laser radiation into the substrate is limited.

16. The method according to claim 10, wherein, during the step of applying the aluminum oxide layer, the substrate is heated.

17. The method according to claim 10, wherein, during the step of applying the aluminum oxide layer, the substrate is heated locally by electromagnetic radiation of a suitable wavelength.
